(19) United States
(12) Patent Application Publication
(10) Pub. No.: US 2025/0236047 A1
(43) Pub. Date: Jul. 24, 2025

(54) MANUFACTURING CARBON-DENSIFIED COMPONENT USING SACRIFICIAL OVERWRAPPING OF WOUND-TAPE PREFORM

(71) Applicant: Textron Systems Corporation, Hunt Valley, MD (US)

(72) Inventors: Michael Robert Favaloro, Amesbury, MA (US); James Gerard Crowley, Arlington, MA (US); Ryan Charles Truhn, Boston, MA (US); Matthew Weis Perrone, Boston, MA (US); Andrew Scott Wallace, Wakefield, MA (US)

(21) Appl. No.: 19/033,987

(22) Filed: Jan. 22, 2025

Related U.S. Application Data
(60) Provisional application No. 63/623,895, filed on Jan. 23, 2024.

(51) Int. Cl. B28B 1/40; B28B 7/34; C04B 35/52; C04B 35/80

(52) U.S. Cl. CPC B28B 1/40; B28B 7/34; C04B 35/52; C04B 35/80; C04B 2235/425; C04B 2235/5248; C04B 2235/5256; C04B 2235/77

(57) ABSTRACT

A method of making a densified carbon component includes wrapping a preform tape of carbon material about a mandrel to form a first preform having a laminated, multi-layer structure, and applying a sacrificial tape overwrap to the first preform in a tensioned manner to form a second preform having the layers of preform tape subject to form-holding hoop stress by the tape overwrap. The second preform is then densified in a densification process to produce the densified carbon component. During densification, the presence of the overwrap helps to prevent undesired delamination or similar defects from occurring.

### BACKGROUND

This invention is generally in the field of strategic materials, and relates specifically to improving the survivability of wound-tape preforms through a carbon/carbon densification process.

### SUMMARY

Carbon has very high heat of ablation and is therefore used as certain high-temperature ablative applications, such as heatshields for reentry and hypersonic applications. However, since the material has nonuniform thermal insulative and thermal expansion characteristics, care must be taken to prevent thermal-shock induced mechanical failure of the material, both in eventual operation (e.g., a reentry environment) and even during manufacturing, in which a carbon/carbon densification process is used that applies considerable stress to preforms (where “carbon/carbon” refers to carbon-reinforced carbon-composite materials, as generally known). It has been known to use reinforcement in three or more directions to control rapid thermal expansion and therefore prevent mechanical failure of preforms and final products. However, multi-directionally reinforced composites are typically significantly more expensive than unidirectional and bidirectional (fabric-based) laminates. For cost-sensitive applications, the utilization of lower cost fiber forms must be considered, while still providing protection against such material failures.

Disclosed herein is an approach that controls thermal-shock induced mechanical loading of carbon/carbon composites to an acceptable level during a densification process and thereby eliminates interlaminar failure without requiring inter-layer reinforcement. Lower cost, thick-walled, fabric-based laminates can be densified into carbon/carbon composites and used as a low-cost thermal protection system for strategic and hypersonic applications, as well as other potential applications including man-rated reentry vehicles, satellites, and interplanetary vehicles.

The disclosed method of making a densified carbon component includes wrapping a preform tape of carbon material about a mandrel to form a first preform having a laminated, multi-layer structure, and applying a sacrificial tape overwrap to the first preform in a tensioned manner to form a second preform having the layers of preform tape subject to form-holding hoop stress by the tape overwrap. The second preform is then densified in a densification process to produce the densified carbon component. During densification, the presence of the overwrap helps to prevent undesired delamination or similar defects from occurring.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a simplified flow diagram of a method of making a densified carbon component, such as a heatshield for example; and

FIGS. 2-7 are views of various components and preforms for an example application of the method to produce a conical heatshield.

### DETAILED DESCRIPTION

### Overview

A carbon/phenolic fabric-based prepreg is typically used in the fabrication of a thermal protection system for heatshields. The material has been used in a bias-cut fabric form laid up in a shingled orientation and wrapped around a conical mandrel before final cure. This construction in a carbon/phenolic heatshield provides excellent ablation performance and thermal insulative characteristics for a typical reentry heatshield. As need for extended range systems increase for hypersonic applications, the same technology can be used in thicker walled constructions and converted to a carbon/carbon construction through any one of a number of carbon/carbon densification processes. However, these constructions are exposed to high internal stresses due to the thicker walls of the more advanced applications and the extreme densification process conditions. These stresses are tensile in nature and can exceed overwhelm the planar properties of a carbon interlaminar matrix in these constructions.

A disclosed technique works by controlling the stresses of the part during the densification process to eliminate interlaminar failure. Before densification, the molded parts are overwrapped under high tension with sacrificial carbon fiber. This overwrap reduces the interlaminar growth of the composite during densification and thereby prevents tensile failure. Such an overwrap can also be effective with a unidirectionally reinforced structure as well.

### Embodiments

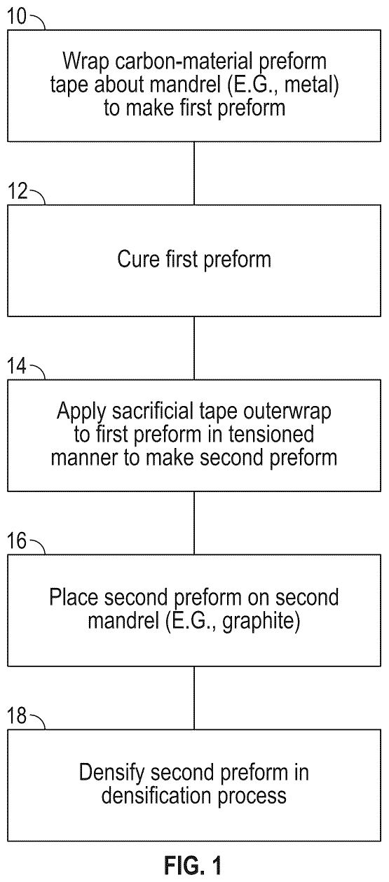

FIG. 1 is a high-level depiction of a method of making a densified carbon component such as a heatshield.

At 10, a preform tape of carbon material is wrapped about a first mandrel to form a first preform having a laminated, multi-layer structure. In one example the carbon material is a carbon phenolic material, which may be reinforced either one-dimensionally (i.e., in long or axial direction of tape) or two-dimensionally (i.e., also in the short or transverse direction of the tape). Winding may be partially or fully automated, such as by use of an automated tape layering (ATL) machine. As described below, the first mandrel is preferably of a strong metal material such as steel or aluminum.

At 12, the first preform is cured, which may be done while the first preform still resides on the first mandrel.

At 14, a sacrificial tape overwrap is applied to the first preform in a tensioned manner to form a second preform in which the layers of preform tape are subject to form-holding hoop stress by the tape overwrap, such as described above. This step may also be performed with the preform still residing on the first mandrel.

At 16, the second preform (overwrapped first preform) is placed onto a second mandrel more suitable for the subsequent densification process, such as a mandrel of a graphite material.

At 18, the second preform is densified in a densification process to produce the densified carbon component. As described above, the presence of the tape overwrap serves to prevent inter-layer delamination that is otherwise a risk of applying densification to a laminated structure. This step is performed with the second preform residing on the second mandrel.

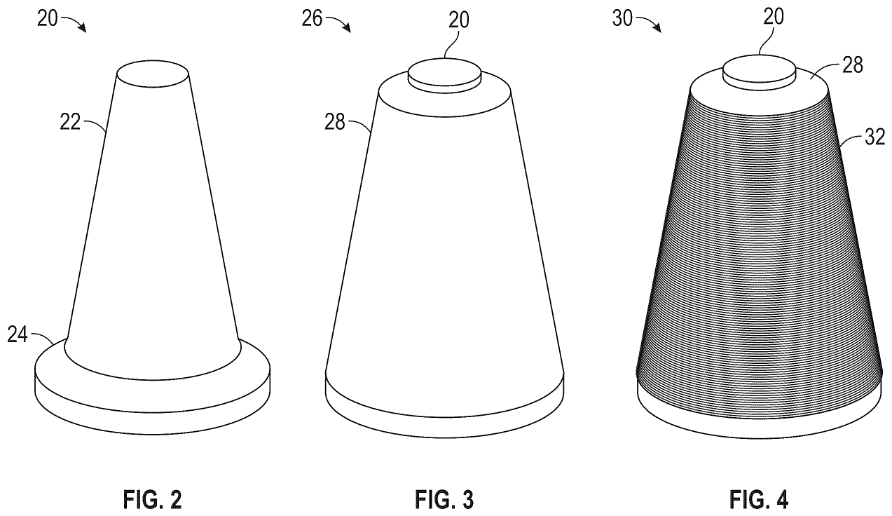

FIGS. 2-7 illustrate components and preforms in an example application of the process of FIG. 1 to make a conical heatshield.

FIG. 2 shows a first mandrel 20 having a conical upper portion 22 and a flared base portion 24. The mandrel 20 serves as a form on which the carbon tape material is wound at step 10 (FIG. 1). The mandrel is preferably made of a strong material, such as steel or other metal alloy, that withstands any significant deformation or other alternation by the harsh densification process.

FIG. 3 shows an intermediate workpiece 26 having a first preform 28 of carbon tape wound in a layered fashion on the first mandrel 20. In one embodiment the carbon tape is of a carbon phenolic material, applied by either manual or automated means (e.g., ATL machine). The workpiece 26 is then subject to a curing process to cure the first preform 28.

FIG. 4 shows a second workpiece 30 which is formed by applying the sacrificial overwrap 32 to the cured first preform 28 of the first workpiece 26. The overwrapped first preform 28 serves as a second preform for further processing. In one embodiment, the overwrap 32 is a unidirectional (UD) fiber wrap with one-dimensional (axial/longitudinal) fiber reinforcement. Additional details are given below. The second preform (overwrapped first preform) is then preferably mounted on a second mandrel (not shown) of a material more suitable for the carbon densification process, such as graphite, and then is densified in the carbon densification process.

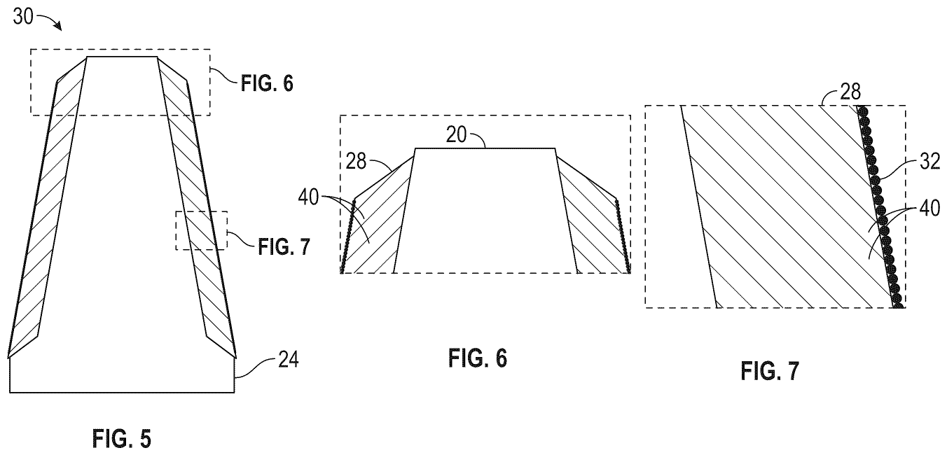

FIGS. 5-7 show certain details of the example application of FIGS. 2-4. FIG. 5 is a cross section view of the second workpiece 30, while FIGS. 6 and 7 are blown-up views of portions 6-6 and 7-7 respectively. FIGS. 6 and 7 both illustrate the manner in which the carbon tape is applied, namely being laid up in a “shingled” manner (from bottom to top of mandrel 20) with substantial overlap between adjacent layers 40. Also, the angle between the tape and the surface of the conical portion 22 of mandrel 20 is selected to control both the extent of overlap and the resulting thickness of the preform 28 (and hence of the resulting heatshield). In the illustrated case, this angle is on the order to 45 degrees and yields a finished heatshield with thickness on the order of 50% of the width of the tape. More generally, steeper tape angling away from the mandrel surface provide for preform width being a substantial fraction (e.g., 50% or more) of the width of the tape, which shallower angles provide for correspondingly thinner parts (less than 50% of tape width). As best shown in FIG. 5, the angle may be established by the angle of the surface of the base portion 24 of the mandrel 20.

FIG. 7 shows the overwrap 32 which in this example is planar rather than shingled, i.e., with successive windings abutting one another. The overwrap 32 is formed by winding a narrow tape material across the outer surface of the first preform 28. Overlapping adjacent layers is generally not required, given the limited purpose of maintaining hoop stress on the layers 40 of carbon tape during subsequent processing. However, those skilled in the art will appreciate that the overwrap 32 may be applied in a variety of ways to achieve this purpose. The overwrap 32 may be installed in generally the same manner as the shingled tape 28, i.e., by tape laying on the first preform 26, perhaps using the same tape-layering machine with suitable manipulation. It could be alternatively wound with an automated tape layering or just a tension winder. No special tooling or processing is necessarily required in placing the overwrap 32 with desired tension. Other overwrap types that provide hoop stress may be used, including braid (biaxial or triaxial), unidirectional tape, filament, tow, or even a fabric wrap.

In the disclosed approach, both the wrap thickness and the wrap tension are important parameters for the overwrap process. The wrap tension is considered the more important of the two as it directly impacts how much pressure is applied to the preform. The success of the overwrap process relies on this pressure to be consistently applied and last throughout the densification processing. The thickness of the wrap can have a major impact of the longevity of the overwrap—the thicker the overwrap the more likely it will hold itself together over a longer period. However, the increase in thickness must be paired with a consistent wrap tension or else the thickness is inconsequential. For example, a thick overwrap that is applied with minimal or inconsistent wrap tension may not perform as well as a thinner overwrap that is applied with increased or more consistent wrap tension. The two parameters are therefore preferably optimized together to an overwrap with desired characteristics and performance.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

While various embodiments of the invention have been particularly shown and described, it will be understood by those skilled in the art that various changes in form and details may be made therein without departing from the scope of the invention as defined by the appended claims.

What is claimed is:

1. A method of making a densified carbon component, comprising:
wrapping a preform tape of carbon material about a mandrel to form a first preform having a laminated, multi-layer structure;
applying a sacrificial tape overwrap to the first preform in a tensioned manner to form a second preform having the layers of preform tape subject to form-holding hoop stress by the tape overwrap; and
densifying the second preform in a densification process to produce the densified carbon component.

2. The method of claim 1, wherein the preform tape is wrapped in a shingled overlapped fashion having overlapping adjacent layers.

3. The method of claim 2, wherein the preform tape is wrapped at an angle to a surface of the mandrel sufficient to yield a thickness of the first preform of greater than 50% of a width of the preform tape.

4. The method of claim 1, wherein the sacrificial tape overwrap is applied in a planar manner having no overlap between adjacent layers.

5. The method of claim 4, wherein the sacrificial tape overwrap is applied such that adjacent layers are abutting.

6. The method of claim 1, wherein the sacrificial tape overwrap comprises a wound reinforced overwrap tape.

7. The method of claim 6, wherein the overwrap tape is one-dimensionally reinforced.

8. The method of claim 7, wherein the overwrap tape is a carbon-fiber tape.

9. The method of claim 6, wherein the overwrap tape is two-dimensionally reinforced.

10. The method of claim 1, wherein the sacrificial tape overwrap is formed of an overwrap tape selected from braid, unidirectional tape, filament, tow, or fabric wrap.

11. The method of claim 1, wherein the sacrificial tape overwrap is applied using a tape-layering machine or a tension winder.

12. The method of claim 1, wherein the mandrel is a first mandrel of a first material, and further including placing the second preform on a second mandrel of a second material for the densification process.

13. The method of claim 12, wherein the first material is a metal material and the second material is a graphite material.
